(19) United States
(12) Patent Application Publication
(10) Pub. No.: US 2015/0363220 A1
(43) Pub. Date: Dec. 17, 2015

(54) VIRTUAL COMPUTER SYSTEM AND DATA TRANSFER CONTROL METHOD FOR VIRTUAL COMPUTER SYSTEM

(71) Applicant: HITACHI, LTD., Tokyo (JP)

(72) Inventors: Yosuke YAMADA, Tokyo (JP); Yuusaku KIYOTA, Tokyo (JP); Tooru IBA, Tokyo (JP)

(21) Appl. No.: 14/763,946

(22) PCT Filed: Feb. 1, 2013
(86) PCT No.: PCT/JP2013/052377

§ 371 Date: Jul. 28, 2015

(51) Int. Cl. G06F 9/455; G06F 3/06; G06F 13/16

(52) U.S. Cl. CPC G06F 9/45558; G06F 13/1642; G06F 3/0689; G06F 3/0613; G06F 3/0665; G06F 2009/45579

(57) ABSTRACT

A computer has an adapter which is coupled to storage devices; the adapter transmits data and receives data, and measures the transfer amount of data that has been transmitted and received, and the number of I/O accesses, for each virtual computer; a virtualization part, on the basis of the transfer amount of the data, and the number of I/O accesses, acquired from the adapter, computes an upper limit for the data transfer amount and an upper limit for the number of I/O accesses for each virtual computer and reports to the virtual computers; and the virtual computers retain the data to transfer to and to receive from the storage devices in a queue, and the virtual computers control data to output from the queue so as not to exceed the upper limit of the data transfer amount or the number of I/O accesses.

### BACKGROUND

The present invention is related to a technology for sharing the HBA (Host Bus Adapter) coupled with a fiber channel among multiple virtual computers

With the development of virtualization technology for computers and cloud computing technology, the system which allows the physical computer resources of a host computer to be used and shared among multiple virtual guest computers (virtual computer) has become commonly used. While the virtual computer system allows the resources of the physical computers to be used in an efficient manner, it also requires the load on the inter-guest computer to be controlled properly. When the load on the guest computers is not controlled, the computer resource shared among multiple guest computers may be occupied by a single guest computer, or the computer resource, which is desired to be saved for a significant guest computer, may potentially be used by guest computers that are not as significant.

In recent years, as the number of cases the virtual computer system is used in mission critical fields is on the rise, it is believed that features, configured to control the computer resources, allocated to each guest computer are going to be more important. In particular, a fiber channel HBA used for communications with a disk apparatus plays a significant role as an interface for the guest computers, the disk apparatus or an SAN (Storage Area Network). Accordingly, realization of a technology that allocates the bandwidth of the fiber channel HBA to each guest computer in an efficient manner in a virtual computer system that includes a plurality of guest computers is desired.

Patent Document 1 includes an example of realizing a bandwidth control for a packet transfer apparatus in a network. According to the Patent Document 1, the bandwidth control is realized by analyzing the size of a transmitted packet at a communication interface whereby the volume of transmitted data is detected so as to control the timing the packet is transmitted.

Non-Patent Document 1 provides an example of a bandwidth control for a fiber channel HBA shared among a plurality of guest computers by using a virtual software. In Non-Patent Document 2, the number of I/O by virtualization software is measured by the parts of SCS I/O so as to control a bandwidth.

### CITATION LIST

Patent document 1: Unexamined Patent Publication No. 2006-109299
Non-Patent Document 1: “FIBER CHANNEL Physical Interface-4 (FC-PI-4) Rev. 7.00” Chapter. 6, Table 6, Single-mode link classes 1 (OS1, OS2) 800-SMLC-L: Data rate: 800 MB/s, [online], Global Engineering, Sep. 20, 2007, [Searched on Jan. 15, 2013]
Non-Patent Document 2: “VMware vSphere 5.0 Evaluation guide Vol. 2: Technical White Paper—High level storage features” p. 48, Confirmation on effect of IOPS control, [online], VMware Inc., [Searched on Jan. 15, 2013]

### SUMMARY

The volume of data that can be transmitted or received per second (MB/s) by one physical HBA port in a fiber channel HBA is defined by a common standard (e.g., Non-Patent Document 1). For example, in an 8 Gbps fiber channel, such volume is 800 MB/sec. Accordingly, in order to secure the transmittable and/or receivable data volume per second for each guest computer sharing an HBA port, a threshold value for the volume of data transmitted and received per predetermined cycle for each guest computer must be arranged so as to control the total volume of data transmitted and received will not exceed the standard of the fiber channel HBA (800 MB/sec. for 8 Gbps).

The technique disclosed in the above stated Non-Patent Document 2 is a method to control the number of SCSI I/O by estimating the load by counting the number of SCSI I/O on an assumption that the number of SCSI I/O is proportional to the volume of data transmitted and received. By using this method, it becomes possible to control the volume of data transmitted and received per control interval for each guest computer of the fiber channel HBA as long as “the volume of data transmitted and received per one SCSI I/O” is constant. However, when “the volume of data transmitted and received per one SCSI I/O” differs depending on the guest computer, in which case the assumption that the number of SCSI I/O is proportional to the volume of data transmitted and received is invalid, it is problematic in that the count for the volume of data transmitted and received per control interval for each guest computer is vastly different from the actual volume of data transmitted and received.

For example, assume between a guest computer 1 and a guest computer 2 that the number of commands for the guest computer 2 is reduced to a one hundredth of that for the guest computer 1 in order to restrict the data transmission and reception volume of the guest computer 2 to one hundredth of that of the guest computer 1. In this case, when “the volume of data transmitted and received per one SCSI I/O” of the guest computer 2 is one hundred times greater than that of the guest computer 1, the number of SCSI I/O of the guest computer 2 may be restricted to one hundredth of that of the guest computer 1, however, the data transmission and reception volume of the guest computer 2 will become substantially the same data transmission and reception volume of the guest computer 1. Accordingly, the goal of restricting the data transmission and reception volume of the guest computer 2 to be one hundredth of that of the guest computer 1 is not met.

The above stated Patent Document 1 is known as an example to achieve the bandwidth control based on the volume of data transmitted and received. However, according to the method of Patent Document 1, since the data volume of packet is added to “a count value that retains the volume of data transmitted and received per control interval,” there is a possibility that there may be a discrepancy between the count value and the actual volume of data transmitted and received.

Consider, for example, an instance where a SCSI I/O command having a frame size of 8 MB is transmitted and received. In this case, according to the method of Patent Document 1, at the point where 1 millisecond has passed since the beginning of the data transmission/reception, it will be counted as 8 MB of data has been transmitted/received while, in reality, only 800 KB worth of data has been transmitted/received. In other words, according to the method according to Patent Document 1, the larger the size of the data transmitted and received by 1 I/O command, the greater the discrepancy between the count value and the actual volume of data transmitted and received.

Meanwhile, in the field of database where communications are implemented in accordance with the SCSI, the volume of data transferred by one SCSI command may sometimes be configured to be large (about 1 MB). In such field, a method in which “even when the size of the data that is transferred by one I/O command is large, there is no discrepancy between the count value and the volume of data transmitted and received that is actually used.”

A representative aspect of the present disclosure is as follows. A virtual computer system having a computer including a processor, a memory, and a virtualization part virtualizing a resource of the computer to allocate the resource to at least one virtual computer, wherein the computer includes an adapter coupled with a storage apparatus, wherein the adapter includes: a transfer processing part configured to transmit and receive data with the storage apparatus, and measure a volume of data transferred and received and a number of I/O for each virtual computer; and a counter configured to store for each virtual computer the volume of the data and the number of I/O, wherein the virtual computer includes: a queue configured to retain data transmitted and received between the storage apparatus; and a bandwidth control part configured to control the volume of the data and the number of I/O, wherein the virtualization part includes: a threshold value calculation part configured to calculate an upper limit of a volume of the data transferred and an upper limit of a number of I/O for each virtual computer based on the volume of the data and the number of I/O obtained from the counter of the adapter; and wherein the bandwidth control part controls the data outputted from the queue to be below the upper limit of the volume of the data transferred and the upper limit of the number of I/O calculated by the virtualization part.

According to the present invention, it becomes possible to achieve the bandwidth control based on the volume of data transmission and reception actually used by each guest computer, not just the bandwidth control based on the number of I/O concerning the I/O of the adapter (e.g., HBA) that is coupled with the storage apparatus. By this, it becomes possible implement accurate bandwidth control for each guest computer without exceeding the HBA bandwidth instead of the conventional bandwidth control which relies on the number of I/O.

### BRIEF DESCRIPTION OF THE DRAWINGS

FIG. 1 is a block diagram illustrating an example of the virtual computer system according to an embodiment of this invention.

FIG. 2 is a block diagram illustrating an example of the hypervisor according to the embodiment of this invention.

FIG. 3 is a block diagram illustrating an example of the guest computer according to the embodiment of this invention.

FIG. 4 is a block diagram illustrating an example of the HBA according to the embodiment of this invention.

FIG. 5 is a sequence diagram illustrating an example of the SCSI I/O process executed by the virtual computer system according to the embodiment of this invention.

FIG. 6 is a sequence diagram illustrating an example of a threshold value update process executed by the virtual computer system according to the embodiment of this invention.

FIG. 7 is a diagram illustrating an example of the threshold value update rule managed by the hypervisor according to the embodiment of this invention.

FIG. 8 is a diagram illustrating an example of the correlation between number of commands and target bandwidth according to the embodiment of this invention.

FIG. 9 is a diagram illustrating an example of the virtual WWN table according to the embodiment of this invention.

### DETAILED DESCRIPTION OF THE EMBODIMENTS

Hereinafter, a virtual computer system to which the present invention is applied will be described in detail with reference to drawings.

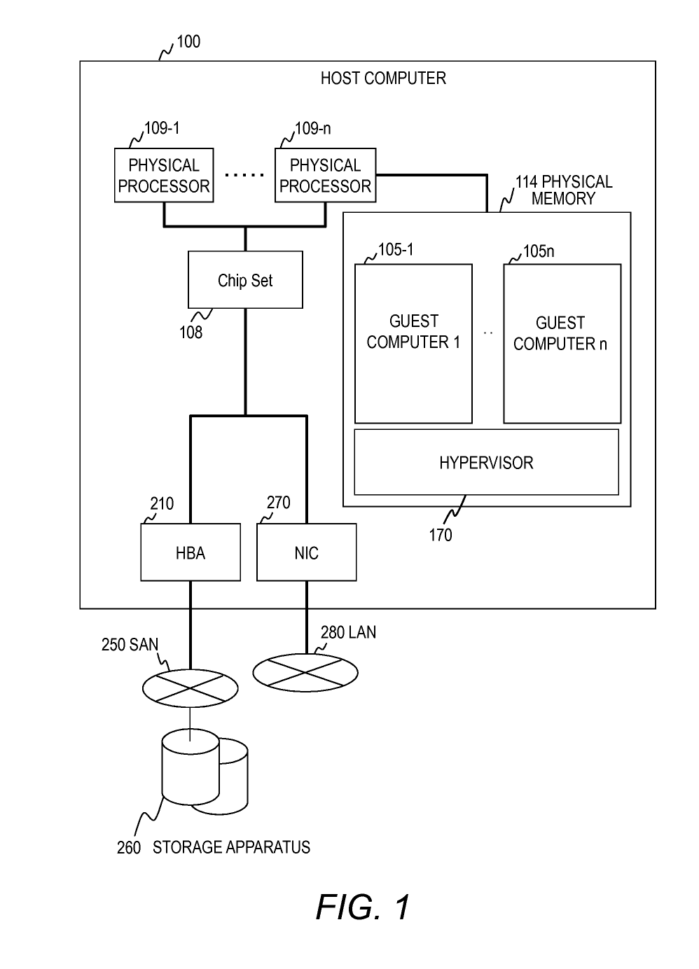

FIG. 1 is a block diagram illustrating an example of the virtual computer system according to the present invention. In FIG. 1, a host computer 100 includes a plurality of physical processors, 109-1 to 109-n, each are configured to execute operations, a physical memory 114 configured to store therein data and programs, an NIC (Network Interface Card) 270 configured to conduct communications with an LAN 280, a fiber channel HBA (HOST BUS ADAPTER) configured to control a storage apparatus 260 via an SAN (Storage Area Network) 250, and a Chip Set 108 configured to couple the fiber channel HBA 210 and the NIC 270 with each physical processor 109-1 through 109-n.

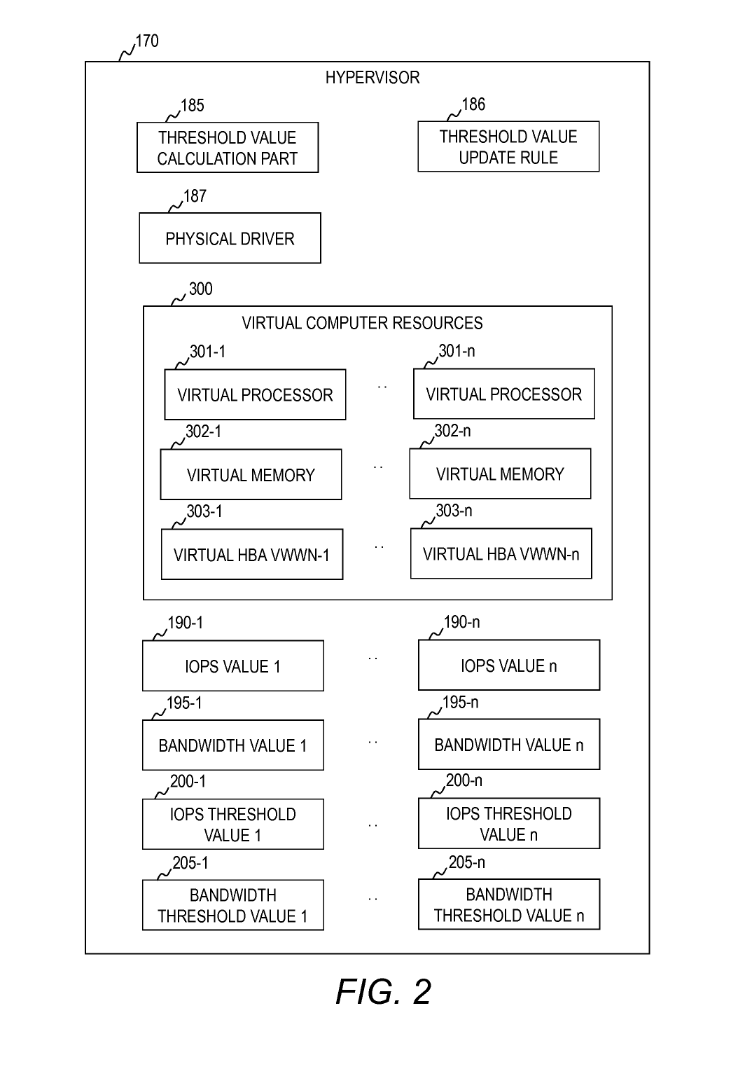

A hyper visor (virtualization part) 170 is configured to divide the physical computer resources of the physical processors 109-1 to 109-n and the physical memory 114 of the host computer 100, generate a virtual computer resource 300 (see FIG. 2), allocate the virtual computer resource (or logical computer resource) such as a virtual processor or a virtual memory to guest computers (or a virtual computer) 1 to n (105-1 to 105-n) so as to configure the guest computers 105-1 to 105-n over the host computer 100.

Note that since the configuration of the guest computer n (105-n) is the same as that of the guest computer 1 (105-1), the description of the guest computer n (105-n) will be omitted while the description of the guest computer 1 (105-1) will be provided. Note in the descriptions below, the guest computers 105-1 to 105-n will be collectively denoted by the reference numeral 105, while the physical processors 109-1 to 109-n will be collectively denoted by the reference numeral 109. Hereinafter, in the similar manner as the above, other reference numerals that indicate components of the present system having a “-” sign will be denoted without said sign.

<Overview>

According to the present invention, the fiber channel HBA (hereinafter, referred to as HBA) 210 is shared among the plurality of guest computers 105, wherein the hypervisor 170 determines the bandwidth of the HBA 210 and the upper limit of the number of I/O used by each of the guest computer 105 for a bandwidth control part included in the virtual driver of each of the guest computer 105 to regulate the HBA 210 bandwidth and the number of I/O.

Accordingly, the bandwidth (data volume) of the HBA 210 and the number of I/O used by each guest computer 105 are measured by a transfer processing part of the HBA 210 for each guest computer 105. Then, the hypervisor 170 obtains the bandwidth and the number of I/O used by each guest computer 105 at prescribed time intervals (e.g., 10 msec.) so as to calculate and update a bandwidth threshold value, which includes an upper limit of the bandwidth of the HBA 210, and an IOPS threshold value (threshold value for the number of I/O), which includes an upper limit for the number of I/O (hereinafter referred to as IOPS), used by each guest computer 105. Note that the IOPS threshold value includes the number of I/O the guest computer 105 is operable to issue at prescribed time intervals. The bandwidth threshold value includes the volume of data the guest computer 105 is operable to transmit and receive at prescribed time intervals. Also note that the prescribed time intervals may include a timer interruption by a guest OS 125, or the like.

As will be described below, the guest computer 105 obtains from the hyper visor 170 the bandwidth threshold value and the IOPS threshold value at a predetermined timing for the bandwidth control part included in the virtual driver to control the bandwidth for the HBA 210.

<Hypervisor>

FIG. 2 is a block diagram illustrating an example of the hypervisor 170.

The hypervisor 170 is a program configured to control the guest computer 105, and is loaded to the physical memory 114 of the host computer 100, and executed by the physical processor 109.

The hypervisor 170 is configured to divide the physical resources of the physical processors 109-1 to 109-n and the physical memory 114 of the host computer 100, generate a virtual computer resource 300 out of virtual processors 301-1 to 301-n, virtual memories 302-1 to 302-n, and virtual HBAs 303-1 to 303-n, and allocate the same to the guest computers 1 to n (105-a to 105-n). Note regarding the NIC 270 that, while not illustrated, the hypervisor 170 is configured to provide a virtual NIC to the guest computer 105 in the same manner as the HBA 210.

The hypervisor 170 allocates virtual WWNs (VWWN-1 to VWWN-n in FIG. 2) to each of the virtual WWN (VWWN-1 to VWWN-n in FIG. 2) which will be allocated to the guest computers 105-1 to 105-n. Then, each time the hypervisor 170 allocates the virtual WWN (World Wide Name) to the virtual HBA 303, the hypervisor 170 notifies to the physical HBA 210 an identifier of said virtual WWB and an identifier of the guest computer 105 to which said virtual HBA 303 is allocated.

The HBA 210, after receiving an SCSI I/O (hereinafter, simply referred to as I/O), specifies the guest computer 105 which issued the I/O based on the identifiers of the virtual WWN and the guest computer 105 notified above. Note that the values of the virtual WWN-1 to VWWN-n the hypervisor 170 allocates to the virtual HBAs 303-1 to 303-n only need to be unique within the virtual computer system.

Then, as stated above, since the hypervisor 170 controls the bandwidth and the I/OPS of the I/O with respect to the HBA 210 for each guest computer 105, the hypervisor 170 includes a threshold value calculation part 185 configured to calculate the bandwidth threshold value and the IOPS threshold value of the I/O, a threshold value update rule 186 configured to retain the rules for updating threshold values, and a physical driver 187 configured to control the HBA 210. Note that, although not illustrated in FIGS., the hypervisor 170 is configured to include a physical driver in order to control other drivers such as the NIC 270. Also, the present embodiment will omit the description of the means to provide virtual computer resources (or, logical computer resources) as techniques that are well-known or previously known may be applied thereto.

The hypervisor 170 retains data and programs by using a predetermined area of the physical memory 114. The hypervisor 170 retains the IOPS values (value for the number of I/O) 1 to n (190-1 to 190-n) storing the IOPS obtained from the HBA 210 for each of the guest computer 1 to n (105-1 to 105-n), the IOPS threshold values 1 to n (200-1 to 200-n) storing the IOPS values calculated by the threshold value calculation part 185, bandwidth values 1 to n (195-1 to 195-n) storing the bandwidth (data transfer volume) of the I/O obtained from the HBA 210, and the bandwidth threshold values 1 to n (205-1 to 205-n) storing the bandwidth threshold value of the I/O calculated by the threshold value calculation part 185.

The threshold value calculation part 185 includes a threshold value calculation program, and is loaded to a predetermined area of the physical memory 114 and executed by the physical processor 109.

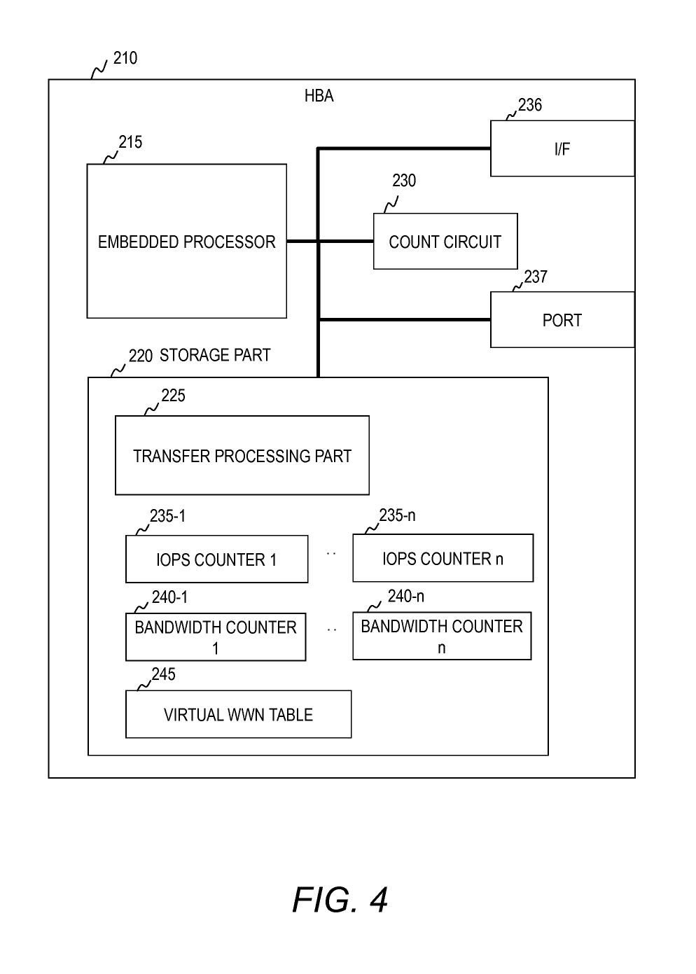

The threshold value calculation part 185 obtains the values for IOPS counter 1 to n (235-1 to n: See FIG. 4) and the values for bandwidth counters 1 to n (240-1 to 240-n: See FIG. 4) measured by the HBA 210, and stores them at the IOPS value 190 and the bandwidth value 195 of the above stated hypervisor 170 so as to update an IOPS threshold value 200 and a bandwidth threshold value 205. Then, based on a notification concerning a completion of the threshold value updates from the threshold value calculation part 185, a virtual driver 130 resets an IOPS value 1′ (150) and a bandwidth value 1′ (155).

Note that when the hypervisor 170 receives an I/O request (read request or write request) from the virtual driver 130 of the guest computers 105-1 to 105-n, the hypervisor 170 transfers the I/O request to the physical HBA 210 by using the physical driver 187. Then, by giving the virtual WWN of the virtual HBAs 303-1 to 303-n to the I/O request, the hypervisor 170 and the physical HBA 210 will become operable to identify the guest computer 105-1 to 105-n which issued the I/O.

Further, the hypervisor 170 receives via the LAN 280 an instruction from a management computer, which is not illustrated, to generate, activate or stop, or delete the guest computer, and controls the allocation of the virtual computer resources.

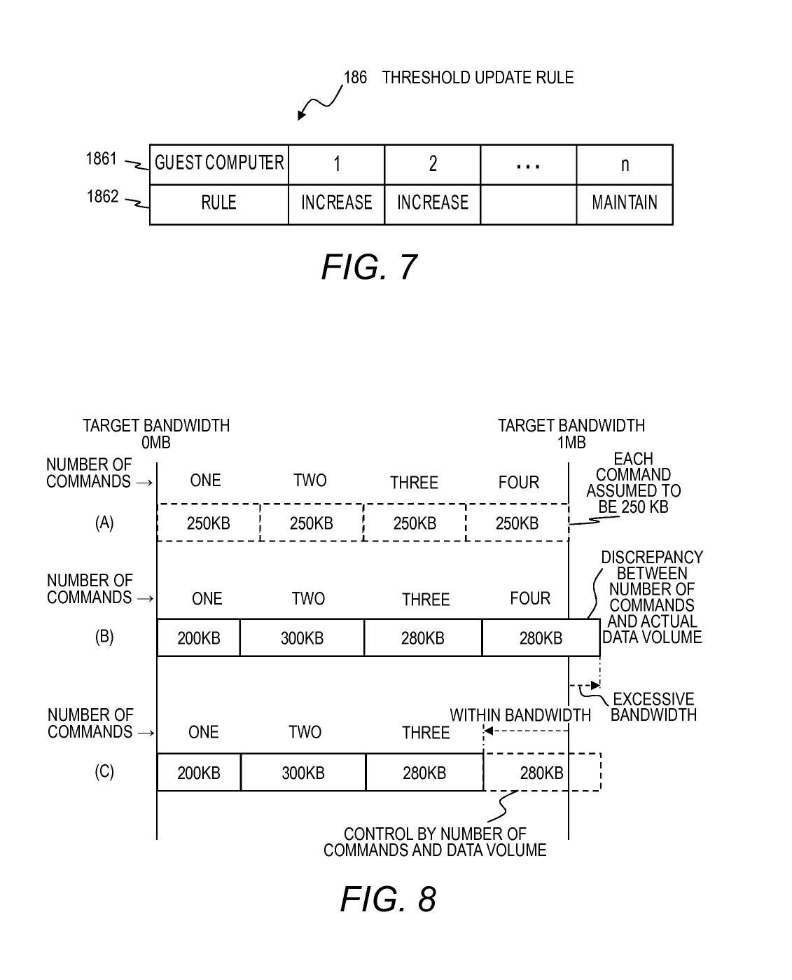

FIG. 7 is a diagram illustrating an example of the threshold value update rule 186 managed by the hypervisor 170. The threshold value update rule 186 includes an entry 1861 configured to store therein the identifiers of the guest computers 105-1 to 105-n, an entry for a rule 1862 configured to store therein the threshold value update rule for each guest computer 105, and a field corresponding to the guest computers 105-1 to 105-n. The rule 1862 stores therein a value received via the LAN 280 from a management computer, which is not illustrated. Here, for the guest computer 105 for which the rule 1862 indicates “increase,” when the IOPS value 150 exceeds an IOPS threshold value 140 or when the bandwidth value 155 exceeds a bandwidth threshold value 145, the bandwidth threshold value 145 which will be used in a next control interval will be increased and the IOPS threshold value 140 will be increased. The increase in the bandwidth threshold value 145 may include a predetermined incremental value. Note, however, that an upper limit to the increase may be arranged for the bandwidth threshold value 145. Further, the increase in the IOPS threshold value 140 may also include a predetermined incremental value with an upper limit arranged for the increase of the IOPS threshold value 140.

<Guest Computer>

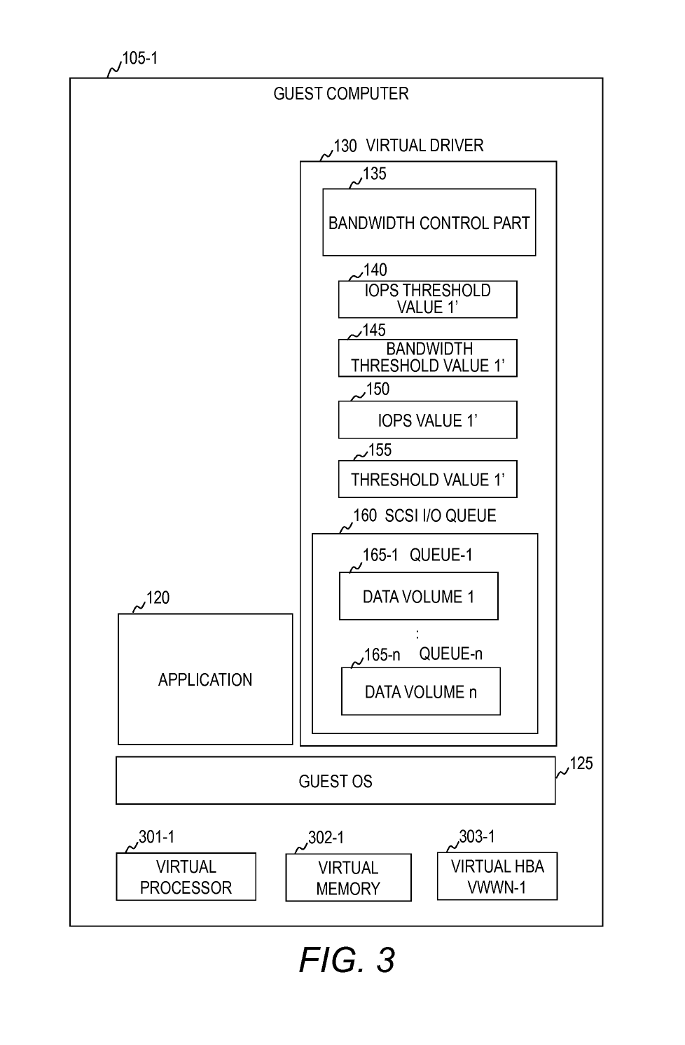

FIG. 3 is a block diagram illustrating an example of the guest computer 105-1. Note that since another guest computer 105-n includes the same configuration as that of the guest computer 105-1, overlapping descriptions will be omitted. The guest computer 105-1 includes a virtual computer which operates over the virtual computer resources provided by the hypervisor 170.

The guest computer 105-1, to which the hypervisor 170 provides the virtual processor 301-1, the virtual memory 302-1, and the virtual HBA 303-1, executes the guest OS 125. The virtual driver 130 which accesses the virtual HBA 303-1 and an application 120 which makes the I/O requests to the virtual driver 130 operate on the guest OS 125. The application 120 includes a software operating on the guest OS 125 configured to request transmission and reception of data to the guest OS 125.

The virtual driver 130 after receiving an I/O request, which is a request from the guest OS 125 to transmit and receive data, includes a program configured to execute the transmission and reception of the data in accordance with the I/O request to the virtual HBA 303-1.

A bandwidth control part 135 of the virtual driver 130 obtains a data volume 165 recorded in the I/O of an SCSI I/O queue (hereinafter, referred to as I/O queue), and controls the volume of I/O issued by the virtual HBA 303-1 (HBA 210) so that the IOPS value 1′ (150) does not exceed the IOPS threshold value 1′ (140) and the bandwidth value 1′ (155) does not exceed the bandwidth threshold value 1′ (145) at prescribed time intervals (i.e., 10 msec.)

The I/O queue 160 includes a plurality of queues, 165-1 to 165-n, and temporarily stores data before it is transmitted or received. The I/O queue 160 includes a storage area configured to temporarily retain the I/O request the virtual driver 130 received from the guest OS 125. Each I/O arranged in the I/O queue 160 stores therein the volume of data which is transmitted or received.

The volume of data that is transferred per predetermined intervals for the virtual HBA 303-1 consists of the IOPS value 1′ (150) which stores the IOPS issued to the virtual HBA 303-1, and the bandwidth value 1′ (155) which stores the volume of data transferred from the virtual HBA 303-1 to the physical driver 187.

Further, the threshold value of the virtual HBA 303-1 obtained from the hypervisor 170 includes the IOPS threshold value 1′ (140) which regulates the IOPS of the HBA 210 associated with the virtual WWN-1 of the virtual HBA 303-1, and the bandwidth threshold value 1′ (145) which stores the value regulating the bandwidth.

The application 120, when access to the storage apparatus 260 occurs, the virtual driver 130 issues an I/O request to the virtual HBA 303-1 and stores data at the I/O queue 160.

The bandwidth control part 135 of the virtual driver 130 gives an instruction to the virtual HBA 303-1 to transfer the data of the queue 160 to the physical driver 187 of the hypervisor 170 when the IOPS value 1′ (150) and the bandwidth value 1′ (155) are within the IOPS threshold value 1′ (140) and the bandwidth threshold value 1′ (145), respectively.

However, the bandwidth control part 135 of the virtual driver 130 holds the I/O request at the queue 160 until a predetermined time interval (i.e., 10 msec.) when either one of the IOPS value 1′ (150) and the bandwidth value 1′ (155) exceeds the IOPS threshold value 1′ (140) or the bandwidth threshold value 1′ (145), and waits until the hypervisor 170 updates the IOPS threshold value 1′ (140) and the bandwidth threshold value 1′ (145).

The bandwidth (volume of data transferred) and the IOPS of the virtual HBA 303-1 (HBA 210) the guest computer 105-1 uses are controlled to be within threshold values at predetermined time intervals by the above stated bandwidth control part 135.

According to the bandwidth control performed by the bandwidth control part 135 of the present invention, the number of I/O requests issued by the guest computer 1 (105-1) and the volume of data transmitted and received by the same are controlled at a certain time intervals (10 msec.) upon establishing threshold values. The threshold values include a value for the number of I/O requests and that for the volume of data transmitted and received (bandwidth), and the bandwidth control is achieved as the bandwidth control part 135 of the virtual driver 130 which controls the virtual HBA 303-1 by the guest computer 105 controls the timing the I/Os are issued.

The IOPS threshold value 1′ (140) includes a variable configured to retain the number of I/O that can be issued by the guest computer 1 (150-1) per control interval. The IOPS value 1′ includes a variable configured to retain the number of I/O issued by the guest computer 1 (150-1) per control interval. The bandwidth threshold value 1′ (145) includes a variable configured to retain the volume of data the guest computer 1 (150-1) is operable to transmit and receive per control interval. The bandwidth value 1′ (155) includes a variable configured to retain the volume of data the guest computer 1 (150-1) transmits and receives per control interval.

At the point in time when the control interval begins the IOPS threshold value 1′ (140) and the bandwidth threshold value 1′ (145) are already configured with the number of I/O the guest computer 105-1 is operable to transmit and receive for said control interval and the volume of data transmitted and received by the guest computer 105-1 for said control interval by the threshold value calculation part 185, which will be described below. The IOPS value 1′ (150) and the bandwidth value 1′ (155) are configured to be reset to 0 per notification from the hypervisor 170 at predetermined control intervals.

The host computer 100 is configured as stated above, while the threshold value calculation part 185 of the hypervisor 170, the guest OS 125, the application 120, the virtual driver 130, and the bandwidth control part 135 are implemented by the physical processor 109 as the programs stored at the physical memory 114.

The physical processor 109 operates as a function part configured to implement predetermined features by operating according to the program of each function part. For example, the physical processor 109 functions as the bandwidth control part 135 by operating according to the bandwidth control part, and functions as the threshold value calculation part 185 by operating according to the threshold value calculation program. This applies to other programs as well. Further, the physical processor 109 operates as the function part for implementing each of various processes executed by each program. The computer and the computer system include the apparatus and the system having these function part.

Programs that are configured to implement each function of the host computer 100, or information such as tables, or the like, may be stored at a storage device such as the storage apparatus 260, non-volatile semiconductor memory, hard disk drive, SSD (Solid State Drive), or the like, or a computer readable non-transitory data storage medium such as IC card, SD card, DVD, or the like.

<HBA>

FIG. 4 is a block diagram illustrating an example of the HBA 210.

The HBA 210 includes an apparatus configured to transmit and receive data between the host computer 100 and a SAN 250 having fiber channels, and the storage apparatus 260.

The HBA 210 includes an embedded processor 215, a storage part 220, a count circuit 230, an I/F part coupled with the host computer 100, and a port 237 coupled with the SAN 250. The I/F part 236 consists of a PCI express, for example.

The count circuit 230 includes a logic circuit configured to measure the volume of data transmitted and received. The storage part 220 includes a transfer processing part 225 configured to execute the process of transmitting and receiving data, IOPS counters 1 to n (235-1 to 235-n) configured to store the measurement results of the number of I/O of the virtual HBA 303-1 to 303-n for each guest computer 105-1 to 105-n, bandwidth counters 1 to n (240-1 to 240-n) configured to store the measurement results of the volume of data transmitted (bandwidth), and a virtual WWN table 245 configured to retain the correlation between the virtual WWN received from the hypervisor 170 and the identifier of the guest computer. The transfer processing part 225 functions as a transfer processing program is loaded to the storage part 220 and the embedded processor 215 is implemented.

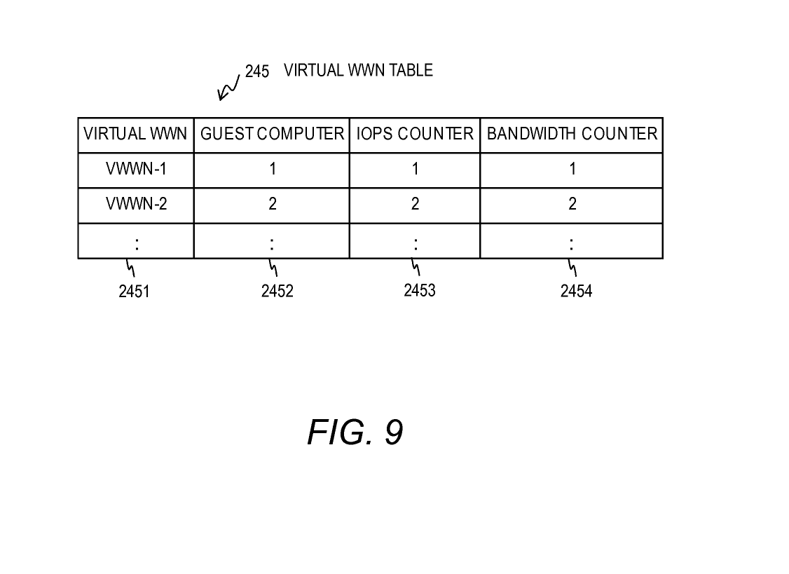

The transfer processing part 225, after receiving the identifier of the virtual WWN and that of the guest computer 105 from the hypervisor 170, correlates the identifier of the virtual WWN and that of the guest computer 105 and stores the same at the virtual WWN table 245. Then, the transfer processing part 225 allocates the IOPS counter 235 and the bandwidth counter 240 to each virtual WWN. FIG. 9 is a diagram illustrating an example of the virtual WWN table 245. The virtual WWN table 245 includes an entry consisting of a column 2451 configured to store the virtual WWN the hypervisor 170 allocates to the virtual HBA 303, a column 2452 configured to store the identifier of the guest computer 105 which allocates the virtual HBA 303 of the virtual WWN, a column 2453 configured to store the identifier of the IOPS 235 the transfer processing part 225 allocates to the virtual WWN, and a column 2454 configured to store the identifier of the bandwidth counter 240 the transfer processing part 225 allocates to the virtual WWN.

Note that the hypervisor 170 allocates each of a plurality of virtual HBAs 303 generated from one physical HBA 210 to each guest computer 105.

The transfer processing part 225 executes communications with the storage apparatus 260 via the SAN 250 in accordance with the I/O request from the host computer 100. At this point, the transfer processing part 225 measures by using the counter circuit 230 the volume of data transmission as bandwidth for each guest computer 105, and stores the same at the bandwidth counter 240. Further, the transfer processing part 225 measures the number of I/O request for each guest computer 105, and stores the same at the IOPS counter 235.

Here, the transfer processing part 225 specifies the guest computer 105, the IOPS counter 235, and the bandwidth counter 240 by referring to the virtual WWN table 245 from the virtual WWN included in the I/O, and stores values at the IOPS counter 235 and the bandwidth counter 240 corresponding to the virtual WWN. For example, when the virtual WWN included in the I/O request is “VWWN-1,” the transfer processing part 225 determines that the I/O request is issued from the virtual HBA 303-1 of the guest computer 105-1, and stores values at the IOPS counter 235-1 and the bandwidth counter 240-1 corresponding to the guest computer 105-1.

Then, as will be described below, the HBA 210, after receiving a request from the hypervisor 170, notifies the values of the IOPS counter 235 and the bandwidth counter 240. Further, the HBA 210 resets the IOPS counter 235 and the bandwidth counter 240 from which the values are read out in accordance with the read out request from the hypervisor 170.

<I/O Process>

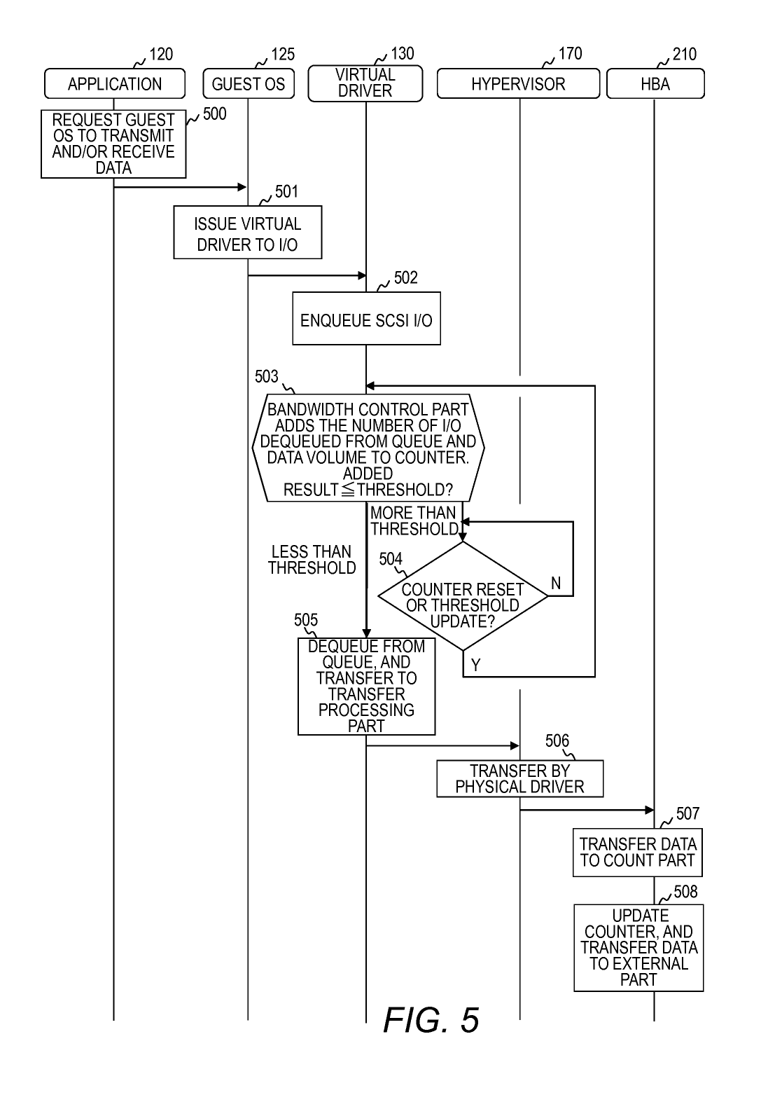

FIG. 5 is a sequence diagram illustrating an example of the SCSI I/O process (hereinafter, referred to as I/O process) executed by the virtual computer system. The sequence diagram illustrated in FIG. 5 will be executed when the application 120 of the guest computer 105 transmits an I/O request to the guest OS 125.

In the present process, first, the OS 125 receives a data transmission reception request issued from the application 120 (Step 500). The guest OS 125 converts the received data transmission reception request into an SCSI I/O, and issues the I/O to the virtual driver 130 (Step 501). Further, the virtual driver 130 enqueues the I/O received from the guest OS 125 to the SCSI I/O queue 160 (Step 502).

Further, the bandwidth control part 135 of the virtual driver 130 makes a determination as to whether or not the guest computer 1 (105-1) is operable to dequeue each I/O from the SCSI I/O queue (Step 503). The determination method will be described below.

When it is determined in Step 503 that dequeuing is possible, the bandwidth control part 135 dequeues the I/Os in the order they were enqueued to the SCSI I/O queue 160, and issues the I/O to the hypervisor 170 (Step 505). The hypervisor 170 transfers the received I/O to the HBA 210 by the physical driver 187 (Step 506).

On the other hand, when it is determined in Step 503 that dequeuing is not possible, as soon as the decision is made, the guest computer 105 is controlled to stop issuing I/Os.

In the above stated process of Step 503 by the bandwidth control part 135, since the I/Os are selected in the order they were enqueued to the SCSI I/O queue 160, and it is determined as to whether or not the guest computer 1 (105-1) is operable to issue the I/O at the control interval, 1 (for said I/O) is added to the IOPS value 1′ (150) of the virtual driver 130, and the data volume indicated in the I/O is added to the bandwidth value 1′ (155).

Then, the bandwidth control part 135 makes a comparison between the IOPS value 1′ (150) and the IOPS threshold value 1′ (140), and further between the bandwidth value 1′ (155) and the bandwidth threshold value 1′ (145) (Step 503).

When the results of the above stated comparison include the IOPS value 1′ (150) being less than the IOPS threshold value 1′ (140) and the bandwidth value 1′ (155) being less than the bandwidth threshold value 1′ (145), the bandwidth control part 135 determines that the guest computer is operable to additionally issue the I/O. Then, the bandwidth control part 135 dequeues the I/O from the SCSI I/O queue 160, and executes an issuing process of the I/O with respect to a transfer processing program 225 of the HBA 210 (Step 505). When the IOPS value 1′ (150) is greater than the IOPS threshold value 1′ (140) or the bandwidth value 1′ (155) is greater than the bandwidth threshold value 1′ (145), the bandwidth control part 135 determines that the guest computer 105 is inoperable to additional issue the I/O. Accordingly, the bandwidth control part 135 will not execute the issuing process of the I/O, and the I/O will remain at the SCSI I/O queue 160 (Step 504). That is, the outputting of the data of the SCSI I/O queue 160 will be inhibited.

Then, in Step 504, when the IOPS value 1′ (150) exceeds the IOPS threshold value 1′ (140) or the bandwidth value 1′ (155) exceeds the bandwidth threshold value 1′ (145), the virtual driver 130 notifies the hypervisor 170 that the threshold has been exceeded.

In a case the I/O remains at the SCSI I/O queue 160, when the control interval ends, the IOPS value 1′ and the bandwidth value 1′ (155) are, as will be described below, reset by the notice from the hypervisor 170, and this works as an opportunity for the bandwidth control part 135 to return to Step 503 to make the comparison again between the results of adding and the threshold values.

After the I/O is transferred by the bandwidth control part 135 via the physical driver 187 of the hypervisor 170 to the transfer processing part 225, the transfer processing part 225 issues the received I/O to the storage apparatus 260. Further, the transfer processing part 225 transfers the issued I/O to the count circuit 230 (Steps 507, and 508).

The count circuit 230 of the HBA 210, after the number of I/O issued to the IOPS counter 235 has been added, adds the volume of data transferred from the beginning to the end of the transfer of the I/O to the bandwidth counter 240 in accordance with the virtual WWN.

Due to the process above, the bandwidth control part 135 of the virtual driver 130 of the guest computer 105 monitors the number of I/O and the volume of data of I/O (bandwidth) so that they do not exceed the IOPS threshold value 1′ (140) and the bandwidth threshold value′ (145) determined by the hypervisor 170 within the predetermined control intervals (e.g., 10 msec.). When the number of I/O or the bandwidth of I/O exceeds the IOPS threshold value 1′ (140) or the bandwidth threshold value′ (145), the bandwidth control part 135 is operable to restrict the number of I/O and the bandwidth of the guest computer 105 to within the threshold values by halting the issuing of I/O during the present control interval.

<Threshold Value Update>

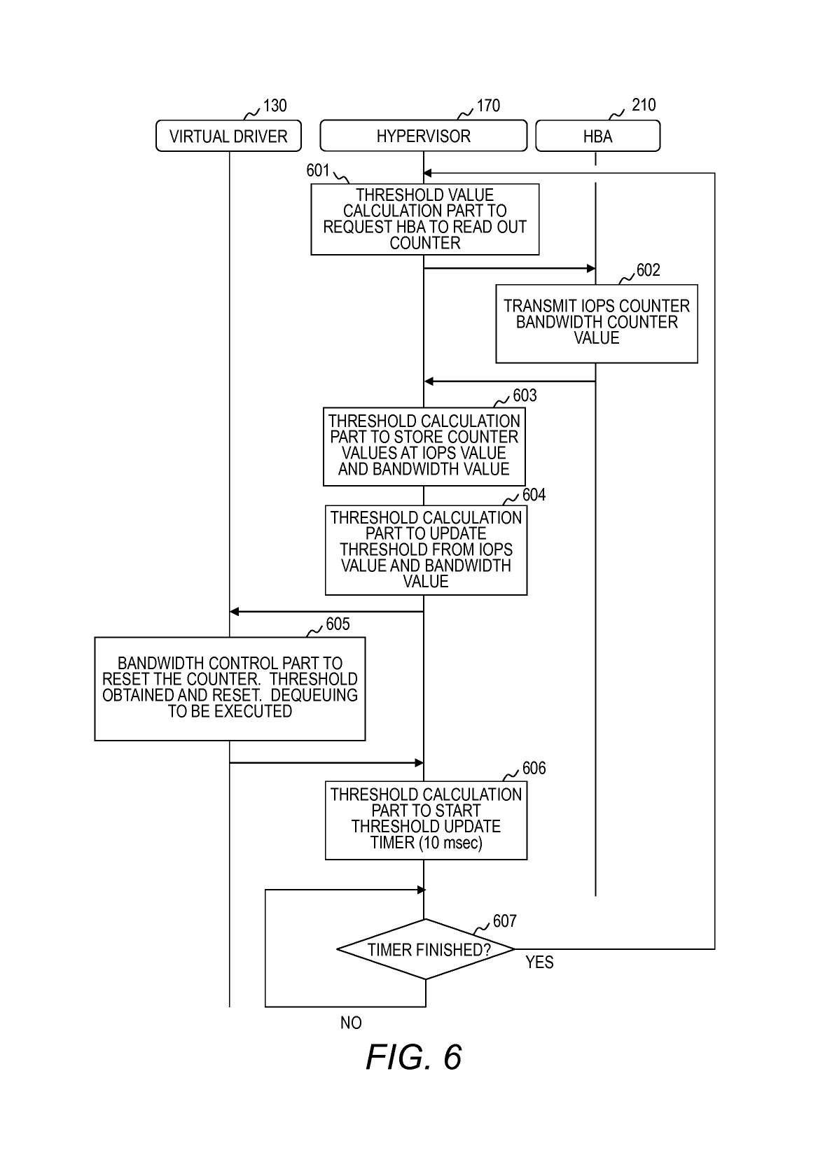

Next, calculation of the IOPS threshold value 200 (140) and the bandwidth threshold value 205 (145) executed in the above stated Step 504 will be described with reference to FIG. 6.

FIG. 6 is a sequence diagram illustrating an example of a threshold value update process executed by the virtual computer system. The process starts stars when the hypervisor 170 boots, and then is repeated per predetermined control interval (e.g., 10 msec.). Hereinafter, while an example of updating the threshold value of the virtual HBA 303-1 allocated to the guest computer 105-1 will be indicated, the threshold value update for other virtual HBAs 303-2 to 303-n may be the same as the example. Note that the threshold value update for other virtual HBAs 303-2 to 303-n may include the implementation of each of the following steps. Alternatively, the timing of the threshold value update of the virtual HBAs 303-1 to 303-n may be altered so as to implement the following Steps 601 to 607 for each virtual HBA 303.

This process includes the process of the threshold value calculation part 185 of the hypervisor 170 receiving the values for the IOPS counter 1 (235-1) and the bandwidth counter 1 (240-1) from the HBA 210, calculating the IOPS threshold value 1 (200-1) and the bandwidth threshold value 1 (205-1), and notifying the completion of the threshold value update to the guest computer 1 (105-1). By this notification, the bandwidth control part 135 of the virtual driver 130 resets the IOPS value 1′ (150) and the bandwidth value 1′ (155) of the guest computer 105-1.

Firstly, the threshold value calculation part 185 of the hypervisor 170 requests the HBA 210 to read out the IOPS counter 1 (235-1) and the bandwidth counter 1 (240-1) (Step 601).

Next, the HBA 201 transmits the requested values of the IOPS counter 1 (235-1) and the bandwidth counter 1 (240-1) to the threshold value calculation part 185 (Step 602). The HBA 201 resets the values of the IOPS counter 1 (235-1) and the bandwidth counter 1 (240-1) that have been read out to 0.

The threshold value calculation part 185 stores the received value of the IOPS counter 1 (235-1) at the IOPS value 1 (190-1) and stores the received value of the bandwidth counter 1 (240-1) at the bandwidth value 1 (195-1).

The threshold value calculation part 185 refers to the threshold value rule 186 so as to obtain the update rule for the threshold value of the guest computer 105-1 allocated to the virtual HBA 303-1 which is the subject to be updated. When the update rule 1862 for the threshold value is “maintain,” the threshold value calculation part 185 maintains the IOPS threshold value 1 (200-1) and the bandwidth threshold value 1 (205-1). Note that when the threshold value is “maintain,” the incremental value for the IOPS threshold value 1 (200-1) and the bandwidth threshold value 1 (205-1) may be set as 0.

On the other hand, the update rule 1862 for the threshold value is “increase,” and when the guest computer 105 received the notification informing that the threshold value has been exceeded in Step 504, which is illustrated in FIG. 5, from the virtual driver 130, the threshold value calculation part 185 updates the IOPS threshold value 1 (200-1) and the bandwidth threshold value 1 (205-1) by adding a predetermined incremental value (Step 604). Note that the predetermined incremental value may be configured independently in advance for the IOPS threshold value 1 (200-1) and the bandwidth threshold value 1 (205-1). Also, the incremental value may be stored at the threshold value rule 186.

Further, the threshold value calculation part 185 notifies the bandwidth control part 135 of the virtual driver 130 operating at the guest computer 105-1 that the update for the IOPS threshold value 1 (200-1) and the bandwidth threshold value 1 (205-1) has been completed.

The bandwidth control part 135, when receiving the threshold value update notification from the hypervisor 170, reads out the IOPS threshold value 1 (200-1) from the hypervisor 170, and stores the same at the IOPS threshold value 1′ (140). Next, the bandwidth control part 135 reads out the bandwidth threshold value 1 (205-1) from the hypervisor 170, and stores the same at the bandwidth threshold value 1′ (145).

Then, when receiving the threshold value update notification from the hypervisor 170, the bandwidth control part 135 resets the IOPS value 1′ (150) and the bandwidth value 1′ (155) retained at the virtual driver 130 (Step 605). Further, the bandwidth control part 135, when there is an I/O remaining at the SCSI I/O queue 160, restarts dequeuing the I/O (Steps 504, 503, and 505 in FIG. 5).

Finally, the threshold value calculation part 185 activates the timer for threshold value update (Step 606), and, when the timer expires in Step 607, executes the update process of the next control interval starting from Step 601 in FIG. 6.

By the process above, in the hypervisor 170, the threshold value calculation part 185 updates the IOPS threshold value 1 (200-1) and the bandwidth threshold value 1 (205-1) based on the value of the IOPS counter 1 (235-1), the value of the bandwidth counter 1 (240-1), and the threshold value update rule 186. Accordingly, the threshold value calculation part 185 is operable to update the IOPS threshold value 1′ (140-1) and the bandwidth threshold value 1′ (145-1) for each virtual HBA 303 of the guest computer 105.

Further, the bandwidth control part 135 of the virtual driver 130 obtains the IOPS threshold value 1′ (140) and the bandwidth threshold value 1′ (145) from the hypervisor 170, and updates the same. The bandwidth control part 135 executes the bandwidth control based on the updated IOPS threshold value 1′ (140) and the bandwidth threshold value 1′ (145). By this, it becomes possible to achieve the bandwidth control based on the volume of data transmitted and received per control interval.

Further, according to the present invention, the HBA 210 measures the bandwidth and the number of I/O for each virtual HBA 303, the hypervisor 170 updates the bandwidth threshold value and the threshold for the number of I/O per control interval, and notifies the guest computer 105, and the virtual driver 130 of the guest computer 105 executes per control interval the bandwidth control of the virtual HBA 303 so that the threshold values for the number of I/O and the bandwidth (the volume of data transferred) are not exceeded. By this, since bandwidth measurement, threshold value calculation, and the execution of bandwidth control are dispersed among the HBA 210, the hypervisor 170, and the guest computer 105, it becomes possible to prevent the work load from being concentrated at one particular unit.

Moreover that the configuration of the computers, or the like, processing parts, and the processing means, or the like, used to describe the present invention may be implemented partially or entirely by an exclusive hardware.

Furthermore, various software exemplified in the present embodiment may be stored at various types of electromagnetic, electronic, or optical storage media (e.g., non-temporary storage medium), and downloaded to a computer via a communication network such as the Internet, or the like.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

What is claimed is:

1. A virtual computer system having a computer including a processor, a memory, and a virtualization part virtualizing a resource of the computer to allocate the resource to at least one virtual computer,
wherein the computer includes an adapter coupled with a storage apparatus,
wherein the adapter includes:
a transfer processing part configured to transmit and receive data with the storage apparatus, and measure a volume of data transferred and received and a number of I/O for each virtual computer; and
a counter configured to store for each virtual computer the volume of the data and the number of I/O,
wherein the virtual computer includes:
a queue configured to retain data transmitted and received between the storage apparatus; and
a bandwidth control part configured to control the volume of the data and the number of I/O,
wherein the virtualization part includes:
a threshold value calculation part configured to calculate an upper limit of a volume of the data transferred and an upper limit of a number of I/O for each virtual computer based on the volume of the data and the number of I/O obtained from the counter of the adapter; and
wherein the bandwidth control part controls the data outputted from the queue to be below the upper limit of the volume of the data transferred and the upper limit of the number of I/O calculated by the virtualization part.

2. A virtual computer system according to claim 1,
wherein the virtual computer includes a bandwidth value configured to store the volume of data transferred, a value for a number of I/O configured to store the number of I/O, a bandwidth threshold value configured to store the upper limit of the volume of data transferred, a threshold value for the number of I/O configured to store the upper limit of the number of I/O, and
wherein the bandwidth control part outputs data from the queue in a case after adding a volume of data transferred each time data is outputted from the queue, adding the number of I/O to the value for the number of I/O, and the bandwidth value is below a bandwidth threshold value and the value for the number of I/O is less than the threshold value for the number of I/O.

3. A virtual computer system according to claim 2,
wherein the bandwidth control part prohibits an output of data from the queue until the bandwidth value and the threshold value for the number of I/O are reset in a case after adding a volume of data transferred each time data is outputted from the queue, adding the number of I/O to the value for the number of I/O, and the bandwidth value exceeds a bandwidth threshold value and the value for the number of I/O exceeds the threshold value for the number of I/O.

4. A virtual computer system according to claim 2,
wherein the threshold value calculation part obtains from the adapter the volume of data transferred and the number of I/O each time a predetermined time period elapses, calculates an upper limit of the volume of the data transferred and an upper limit of the number of I/O for each virtual computer from the volume of data transferred and the number of I/O based on a predetermined rule, and notifies the upper limit of the volume of the data transferred and the upper limit of the number of I/O to the virtual computer, and
wherein the bandwidth control part, based on the notification received from the threshold value calculation part of the upper limit of the volume of the data transferred and the upper limit of the number of I/O, resets a bandwidth value of the virtual computer and the value for the number of I/O.

5. A virtual computer system according to claim 4,
wherein the predetermined rule includes adding an incremental value predetermined for each virtual computer.

6. A method to control a data transfer for a virtual computer system having a computer including a processor, a memory, and a virtualization part virtualizing a resource of the computer to allocate the resource to at least one virtual computer,
wherein the computer includes an adapter coupled with a storage apparatus, and
wherein the adapter includes:
a first step, by the adapter, of transmitting and receiving data with the storage apparatus, and measuring a volume of data transferred and received and a number of I/O for each virtual computer;
a second step, by the virtualization part, of calculating an upper limit of a volume of the data transferred and an upper limit of a number of I/O for each virtual computer based on the volume of the data and the number of I/O obtained from the adapter, and notifying the upper limit of the volume of the data transferred and the upper limit of the number of I/O to the virtual computer;
a third step, by the virtual computer, of retaining data transmitted and received with the storage apparatus at a queue; and
a fourth step, by the virtual computer, of controlling the data outputted from the queue to be below the upper limit of the volume of the data transferred and the upper limit of the number of I/O.

7. A data transfer control method for the virtual computer system according to claim 6,
wherein the second step includes a step, by the virtual computer, of storing the volume of data transferred at a bandwidth value, storing the number of I/O at a value for the number of I/O, storing the upper limit of the volume of data transferred at a bandwidth threshold value, and
wherein the fourth step includes a step, by the virtual computer, of outputting data from the queue in a case after a volume of data transferred each time data is outputted from the queue, adding the number of I/O to the value for the number of I/O, and the bandwidth value is below a bandwidth threshold value and the value for the number of I/O is less than the threshold value for the number of I/O.

8. A data transfer control method for the virtual computer system according to claim 7,
wherein the fourth step includes prohibiting, by the virtual computer, an output of data from the queue until the bandwidth value and the threshold value for the number of I/O are reset in a case after adding a volume of data transferred each time data is outputted from the queue, adding the number of I/O to the value for the number of I/O, and the bandwidth value exceeds a bandwidth threshold value and the value for the number of I/O exceeds the threshold value for the number of I/O.

9. A data transfer control method for the virtual computer system according to claim 7,
wherein the second step includes:
a step, by the virtual computer, of obtaining from the adapter the volume of data transferred and the number of I/O each time a predetermined time period elapses, calculating an upper limit of the volume of the data transferred and an upper limit of the number of I/O for each virtual computer from the volume of data transferred and the number of I/O based on a predetermined rule, and notifying the upper limit of the volume of the data transferred and the upper limit of the number of I/O to the virtual computer; and
a step, by the virtual computer, of resetting, based on the notification received from the threshold value calculation part of the upper limit of the volume of the data transferred and the upper limit of the number of I/O, a bandwidth value of the virtual computer and the value for the number of I/O.

10. A data transfer control method for the virtual computer system according to claim 9,
wherein the predetermined rule includes adding an incremental value predetermined for each virtual computer.
